(19) United States
(12) Patent Application Publication
(10) Pub. No.: US 2005/0013220 A1
(43) Pub. Date: Jan. 20, 2005

(54) Method of driving step motor of compact disc drive

(75) Inventor: Jum-Soon Seo, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/747,244

(22) Filed: Dec. 30, 2003

(30) Foreign Application Priority Data
Jan. 3, 2003 (KR) 2003-375

(51) Int. Cl. G11B 5/09

(52) U.S. Cl. 369/47.36; 369/47.43

(57) ABSTRACT

A method of driving a step motor of an optical disc drive where a shift distance of an optical pickup lens of the optical disc drive is detected. A step motor driver is turned off so that a signal to drive the step motor is not output when the optical pickup lens shifts within a predetermined range from the center of the optical pickup.

### CROSS-REFERENCE TO RELATED APPLICATIONS

This application claims the priority of Korean Patent Application No. 2003-375, filed on Jan. 3, 2003, in the Korean Intellectual Property Office, the disclosure of which is incorporated herein in its entirety by reference.

### BACKGROUND OF THE INVENTION

1. Field of the Invention

The present invention relates to a method of driving a step motor of an optical disc drive, and more particularly, to a method of driving a step motor of an optical disc drive by which current consumption of the optical disc drive is reduced by turning off a step motor driver so that a signal to drive the step motor is not output and tracking an optical pickup when an optical pickup lens of the optical disc drive is located within an allowable range or when a feed motor output (FMO) signal varies within a predetermined range.

2. Description of the Related Art

As is known, optical discs such as compact disc read only memories (CD-ROM), digital versatile disc read only memories (DVD-ROMs), and the like have a diameter of several centimeters and a thickness of 1.2 mm. Also, optical discs have a storage capacity of several megabytes several hundreds times larger than the storage capacity of common floppy discs, and have a reflective surface as a recording layer. The optical discs store information such as sound, letters, graphics, and so forth in the form of combinations of pits formed in the reflective surface. With the advancement of such optical discs, optical disc drives have been developed to precisely and rapidly read micro-high density data.

Such an optical disc drive jumps or follows tracks formed on an optical disc such as a CD-ROM, a DVD-ROM, a DVD, or the like to accurately play back data from the optical disc. When the optical disc drive follows the tracks, the optical disc drive moves an optical pickup using a general direct current (DC) motor or a step motor.

The step motor is more commonly used as a tracking motor for several reasons. First, because the DC motor operates slowly, the DC motor cannot rapidly accelerate and decelerate in a short distance. Second, it is difficult to precisely control the DC motor when the optical disc is played back. In other words, when the DC motor rotates, a gear rotates, resulting in a rectilinear movement of the optical pickup. As a result, the backlash of the rotating gear affects the precise control of the DC motor.

FIG. 1 is a schematic block diagram of a servo system used to control a motor of a conventional optical disc drive. Referring to FIG. 1, an optical pickup 101 radiates light onto an optical disc and detects the light reflected from the surface of the optical disc to reproduce information from the optical disc. An actuator driver 102 precisely moves light emitting diodes such as a laser diode, a lens, and the like installed in the optical pickup 101 in tracking and focusing directions. A high frequency amplifier 103 detects a high frequency component from a reproduction signal detected by the optical pickup 101 and amplifies the high frequency (RF) signal to a level appropriate for signal processing. A servo controller 104 detects a tracking error from the RF signal output from the high frequency amplifier 103 to control the driving of the actuator driver 102. In other words, the servo controller 104 detects a tracking error signal from the RF signal to output a binarized tracking error zero cross (TEZC) signal to a microcomputer 107. The servo controller 104 also outputs a feed motor output (FMO) signal to the microcomputer 107. A step motor 105 moves the optical pickup 101 from an inner perimeter of the optical disc to an outer perimeter of the optical disc or vice versa. A step motor driver 106 controls the rotation of the step motor 105 so as to control the movement distance of the optical pickup 101 during a track search, a track jump, or other read operations. The microcomputer 107 controls the overall operation of the optical disc drive. In particular, the microcomputer 107 calculates a number of steps of the step motor 105 in response to the TEZC signal and the FMO signal and outputs pulse width modulation signals PWM0 and PWM1 to the step motor driver 106 based on the calculation values to correspondingly move the step motor 105.

The structure of the microcomputer 107 will now be described in detail. A counter 108 counts pulses of the TEZC signal output from the servo controller 104 and a digital FMO signal output from an analog-to-digital (AD) converter 109 to detect tracking errors. The AD converter 109 converts the analog FMO signal from the servo controller 104 into the digital FMO signal. A track jump storage 110 stores a number of micro-steps respectively corresponding to a number of tracks of each type of optical disc such as a CD, a DVD, and the like in a look-up table to provide the number of micro-steps to the step motor 105. Here, the number of micro-steps refers to N values into which a step of the step motor 105 is divided. Values into which a system clock is divided are determined as the N values. A track-related micro-step storage 111 stores an amplitude of a current corresponding to the number of micro-steps output from the track jump storage 110 in the look-up table. A pulse width modulation signal generator 112 outputs the pulse width modulation signals PWM0 and PWM1 with a duty varying according to the amplitude of the current output from the track-related micro-step storage 111 to the step motor driver 106.

Accordingly, when an optical disc drive is driven by a step motor, a spindle motor (not shown) performs about 5000 RPM at a 24×—constant angular velocity (CAV) of an optical disc. At 5000 RPM, the spindle motor performs one complete rotation in 12 ms, while the step motor moves 1 micro-step per 10-rotations. Here, 1 micro-step corresponds to 8.6 tracks.

The step motor does not perform stepping for 1 micro-step but continuously outputs a predetermined vector value to maintain its current position. As a result, for tracking purposes, the step motor consumes more power than the DC motor.

### SUMMARY OF THE INVENTION

The present invention provides a method of driving a step motor of an optical disc drive by which current consumption is reduced by turning off the step motor so that a signal to drive the step motor is not output when an optical pickup lens, for example, an objective lens of an optical pickup, is located within an allowable range or when an FMO signal varies within a predetermined range.

According to an aspect of the present invention, there is provided a method of driving a step motor of an optical disc drive. A shift distance of an optical pickup lens of the optical disc drive is detected. A step motor driver is turned off so that a signal to drive the step motor is not output when the optical pickup lens shifts within a predetermined range from the center of an optical pickup.

Additional aspects and/or advantages of the invention will be set forth in part in the description which follows and, in part, will be obvious from the description, or may be learned by practice of the invention.

In an aspect of the present invention, the optical pickup lens shifts within a range of ±70 μm from the center of the optical pickup to stop driving the step motor. When the optical pickup lens is not in the range of ±70 μm, the step motor moves by 8 milliseconds four consecutive times so as to move by a half-step. The step motor moves by a half step before stopping.

According to another aspect of the present invention, there is provided a method of driving a step motor of an optical disc drive. When a feed motor output signal varies within a predetermined range, driving of the step motor stops by turning off a step motor driver so that a signal to drive the step motor is not output.

When the optical pickup lens is not in the range of ±70 μm, the step motor moves by 8 milliseconds four consecutive times to move by a half-step.

### BRIEF DESCRIPTION OF THE DRAWINGS

These and/or other aspects and advantages of the invention will become apparent and more readily appreciated from the following description of the exemplary embodiments, taken in conjunction with the accompanying drawings of which:

FIG. 1 is a schematic block diagram of a servo system used to control a motor of a conventional optical disc drive;

FIG. 2A is a flowchart of a method of driving a step motor of an optical disc drive, according to an embodiment of the present invention;

FIG. 2B is a flowchart of a method of driving a step motor of an optical disc drive, according to another embodiment of the present invention;

FIG. 3 is a conceptual view explaining a method of driving a step motor of an optical disc drive;

FIG. 4 is a graph showing current signals to drive a step motor of a conventional optical disc drive; and

FIG. 5 is a graph showing current signals to drive a step motor of an optical disc drive, according to an embodiment of the present invention.

### DETAILED DESCRIPTION OF THE EMBODIMENTS

Reference will now be made in detail to the embodiments of the present invention, examples of which are illustrated in the accompanying drawings wherein like reference numerals refer to the like elements throughout. The embodiments are described below in order to explain the present invention by referring to the figures.

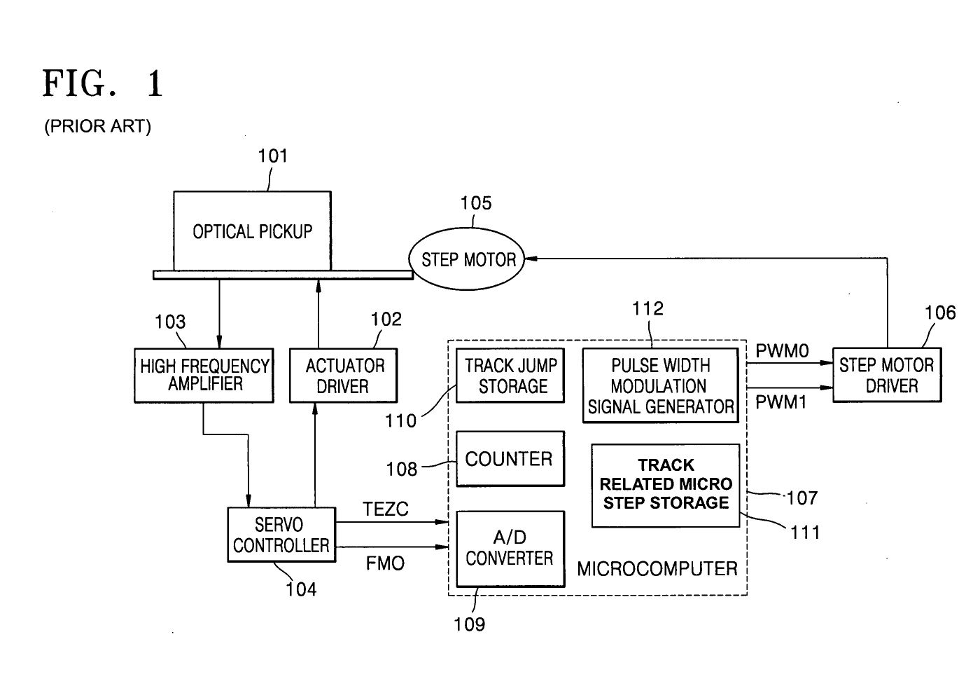

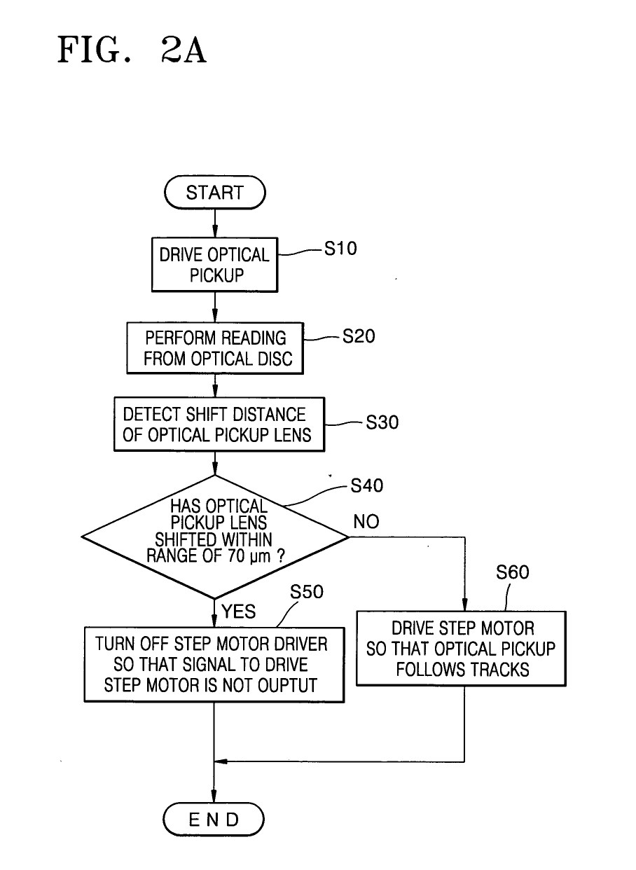

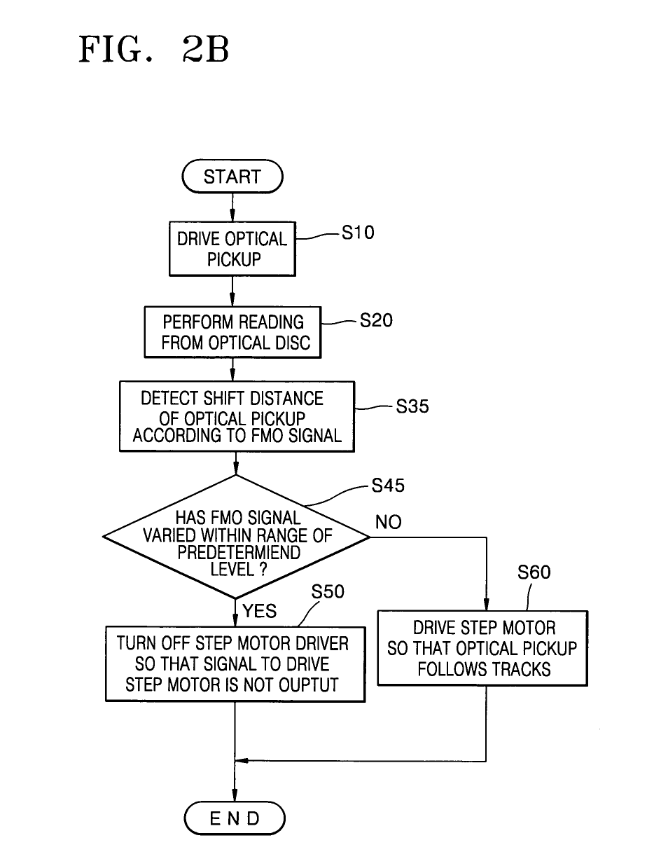

FIG. 2A is a flowchart of a method of driving a step motor of an optical disc drive, according to an embodiment of the present invention, and FIG. 3 is a conceptual view of a method of driving a step motor of an optical disc drive, according to an embodiment of the present invention. The method of the present invention may be implemented in the conventional optical disc drive shown in FIG. 1. Referring to FIGS. 2A and 3, in operation S10, the optical pickup 101 is driven. In operation S20, reading from an optical disc is performed. In operation S30, a shift distance of an optical pickup lens 101a is detected. In operation S40, a determination is made as to whether the optical pickup lens 101a has been shifted within a predetermined range, for example, within a range of 70 μm. If in operation S40, it is determined that the optical pickup lens 101a has been shifted within the range of ±70 μm, in operation S50, the step motor driver 106 of FIG. 1 is turned off so that a signal to drive the step motor 105 is not output. If in operation S40, it is determined that the optical pickup lens 101 a has not been shifted within the range of ±70 μm, in operation S60, the step motor 105 is driven so that the optical pickup 101 follows the tracks of an optical disc.

FIG. 2B is a flowchart of a method of driving a step motor of an optical disc drive, according to another embodiment of the present invention. Referring to FIGS. 2B and 3, in operation S10, the optical pickup 101 is driven. In operation S20, reading from an optical disc is performed. In operation S35, a shift distance of the optical pickup lens 101a is detected from an FMO signal output from the servo controller 104 of FIG. 1. In operation S45, a determination is made as to whether the FMO signal varies within a predetermined range, for example, has a level so that the optical pickup lens 101a shifts within a range of ±70 μm from the center of the optical pickup 101. If in operation S45, it is determined that the FMO signal varies within the predetermined range, in operation S50, the step motor driver 106 is turned off so that a signal to drive the step motor 105 is not output. If in operation S45, it is determined that the FMO signal varies above the predetermined range, in operation S60, the step motor 105 is driven so that the optical pickup 101 follows the tracks of an optical disc.

It will be obvious to those of ordinary skill in the art that the method of FIG. 2A is the same as the method of FIG. 2B except that the shift distance of the optical pickup lens 101a is detected in a different way.

A method of driving a step motor of an optical disc drive will be explained in detail with reference to FIGS. 1 through 5.

The optical disc drive detects the shift distance of the optical pickup lens 101a. The optical disc drive drives the step motor 105 based on the shift distance of the optical pickup lens 101a to control the optical pickup lens 101a to be located in the center of the optical pickup 101. In other words, in the method of FIG. 2A or 2B, when the FMO signal varies within the predetermined range or when the optical pickup lens 101a is shifted within the range of 70 μm from the center of the optical pickup 101, the step motor driver 106 is turned off so that a signal to drive the step motor 106 is not output.

Accordingly, the step motor 105 does not need to be continuously driven during reading operations from an optical disc. Instead, when the optical pickup lens 101a is located within a window width, i.e., within a range of 70 μm from the center of the optical pickup 101, as shown in FIG. 3, the step motor driver 106 is turned off so that the signal to drive the step motor 105 is not output to reduce current consumption.

As shown in FIG. 3, when the level of the FMO signal is located between position A and position B (within a window width of FIG. 3) or when the optical pickup lens 101a is located within the range of ±70 μm, the step motor driver 106 is turned off so that the signal to drive the step motor 105 is not output. In this case, the step motor 105 must continue stepping. Thus, the step motor 105 moves by a half of a step before stopping. In this case, although the step motor 105 is turned off for a predetermined period of time, the step motor 105 remains in the current position. Here, the step motor 105 remains in the current position due to load and backlash between a guide member and a lead screw.

In the present invention, the shift distance of the optical pickup lens 101a from the center C of the optical pickup 101 to position B was set to 70 μm when designing the optical disc drive. In other words, when the optical pickup lens 101a moves 70 μm from the center C, the optical disc drive half steps the step motor 105 by 8 milliseconds four consecutive times. The optical pickup lens 101a is then shifted toward the inner perimeter, i.e., position A. When the optical pickup lens 10la moves from position A to position B, the step motor driver 106 is turned off so that the signal to drive the step motor 105 is not output.

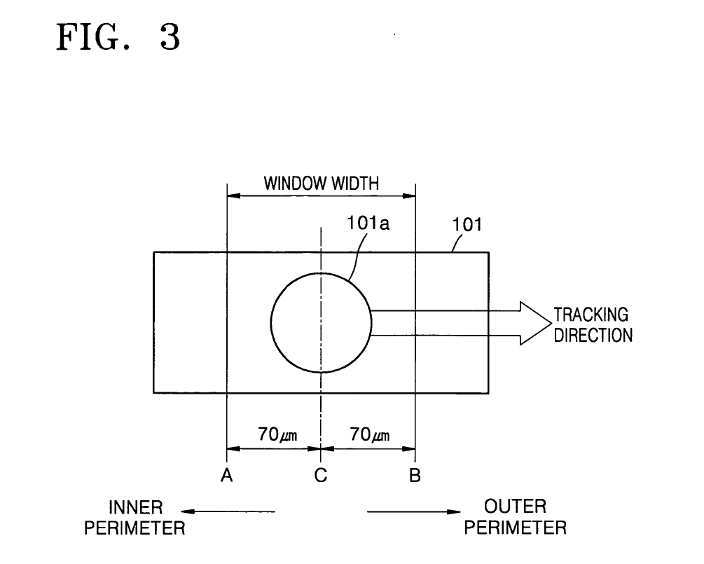

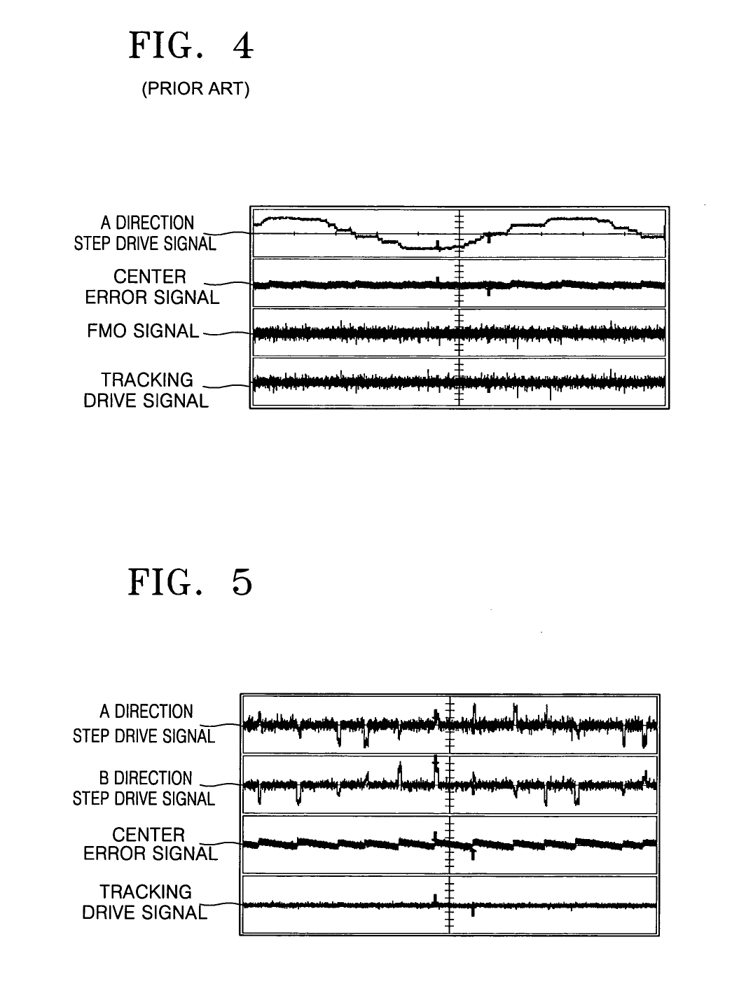

Accordingly, as can be seen in FIGS. 4 and 5, a current to drive a step motor according to the present invention can be reduced compared to the related art.

As described above, in a method of driving a step motor of an optical disc drive according to the present invention, when an optical pickup lens of the optical disc drive is located within an allowed range or when an FMO signal is offset within a predetermined range, a step motor driver can be turned off so that a signal to drive the step motor is not output. As a result, current consumption of the optical disc drive can be reduced. It is understood that though the present invention would work with optical disc drives that write information as well as read information, such as CD-R/W, CD-R, DVD-R/W, DVD-R, etc.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of driving a step motor of an optical disc drive, comprising:
detecting a shift distance of an optical pickup lens of the optical disc drive; and
turning off a step motor driver so that a signal to drive the step motor is not output when the optical pickup lens shifts within a predetermined range from a center of an optical pickup.

2. The method of claim 1, wherein the optical pickup lens shifts within a range of ±70 μm so as to stop driving the step motor.

3. The method of claim 1, wherein when the optical pickup lens is not in a range of ±70 μm, the step motor moves by 8 milliseconds four consecutive times so as to move by a half-step.

4. The method of claim 1, wherein the step motor moves a half step before stopping.

5. A method of driving a step motor of an optical disc drive, comprising:
stopping driving the step motor by turning off a step motor driver so that a signal to drive the step motor is not output when a feed motor output signal varies within a predetermined range.

6. The method of claim 5, wherein when the feed motor output signal is not in the range corresponding to an optical pickup lens in a range of ±70 μm, the step motor moves by 8 milliseconds four consecutive times.

7. The method of claim 5, wherein the step motor moves by a half step before stopping.

8. A method of controlling a step motor of an optical disc drive comprising:
driving an optical pickup of the optical disc drive in response to a step motor driver;
reading from an optical disc with an optical pickup lens;
determining a shift distance of the optical pickup lens corresponding to a center of the optical pickup;
stopping the step motor driver of the optical disc drive based upon the determined shift distance being within a predetermined range; and
driving the step motor driver of the optical disc drive based upon the determined shift distance being outside of the predetermined range, wherein the step motor driver controls the step motor.

9. The method of claim 8, wherein the predetermined range corresponds to a distance of ±70 μm from the center of the optical pickup.

10. The method of claim 9, wherein the step motor is driven by a predetermined number of pulses output by the step motor driver when the optical pickup lens is not within the predetermined range.

11. The method of claim 8, wherein the predetermined range is based on a feed motor output (FMO) signal.

12. The method of claim 11, wherein the step motor is driven by a predetermined number of pulses output by the step motor driver when the optical pickup lens is not within the predetermined range.

13. An optical disc drive system for an optical disc comprising:
a motor to rotate the optical disc,
an optical pickup to read/write to the optical disc with an optical pickup lens;
a step motor driver;
a step motor to move the optical pickup across a surface of the optical disc based on signals from the step motor driver;
a servo controller to determine a feed motor output signal; and
a controller to control the step motor driver based on the feed motor output signal.

14. The system of claim 13, wherein the controller turns off the step motor driver when the optical pickup lens is in a predetermined window of the optical pickup.

15. The system of claim 14, wherein the predetermined window corresponds to a range of feed motor output signals.

16. The system of claim 15, wherein the range of feed motor output signals corresponds to a distance of approximately ±70 μm from a center of the optical pickup.
